(19) United States
(12) Patent Application Publication
(10) Pub. No.: US 2012/0271779 A1
(43) Pub. Date: Oct. 25, 2012

(54) UNIFYING DOMAIN MODEL FOR INTERNET BUSINESS SYSTEMS

(75) Inventors: Ryan R. Donovan, Ottawa (CA); Donna J. Remillard, Saint-Lazare (CA); Cameron P. Stevenson, Oxford Station (CA)

(73) Assignee: CACTUS COMMERCE INC., Gatineau (CA)

(21) Appl. No.: 13/090,085

(22) Filed: Apr. 19, 2011

(51) Int. Cl. G06Q 10/00

(52) U.S. Cl. 705/348

(57) ABSTRACT

A unifying domain model for Internet business systems is described that includes an authoritative definition of logical objects that make up a modern Internet business system, a canonical list of attributes associated with such objects, a specification of how such objects may be composed and may relate to one another, and what operations or actions may be taken on or provided by them. A middleware framework is also described that brokers communication between end-user applications that are designed to consume the aforementioned objects and various integrated systems that are not so designed, such as LOB systems and partner systems, wherein brokering communication may include performing a translation between a representation of the data and operations utilized by an integrated system and the unifying domain model utilized by the end-user applications during runtime of the end-user applications.

### BACKGROUND

Modern Internet business systems are not atomic entities, but consist of a multitude of heterogeneous integrated and peripheral systems. Such systems may include, for example and without limitation: product catalog systems, discount systems, advertising systems, monetary transaction systems, inventory management systems, Web content management systems, search systems, analytics systems, personalization systems, varying presentation systems that span a multitude of devices and consumption scenarios, systems for integrating to Web information portals (such as Google® for publishing), and systems for integrating to Web information brokers for data consumption (such as leveraging a Web analytics tool) or for bi-directional data syndication (such as integrating with social networks). Each of these systems can and often do make use of their own data or service models and application programming interfaces (APIs) that may span technologies and computer languages.

These integrated systems may be individual user interface (UI) components, back-end line of business (LOB) systems, management tools, information brokers, or entire UI suites.

Both the core Internet business system and the systems integrated therewith may be constructed on different computer platforms and support different integration standards in addition to having unique data or service models and APIs.

The connection of the core Internet business system and the integrated systems presents two related challenges. First, developers of an Internet business system must design the system to connect to a variety of integrated systems. Second, developers of an integrated system are motivated to design the integrated system so that it supports multiple Internet business systems, which may operate on different platforms, operating systems and computer languages. Because a modern Internet business system consists of an extremely large number of integrated components, the task of integrating has become onerous, time-consuming and defect prone.

Outside of the mechanics of connecting an Internet business system and one or more integrated systems, there is also the very real problem of the lack of shared semantic definitions for meta-information, operations and relationships between objects defined in an Internet business system, which results in defects and the appearance of non-optimal, non-intuitive behavior to an end user.

Further to the lack of shared semantic definitions, there is also an overriding issue with respect to the ability to capture analytic and compliance related data across the breadth of integrated systems. For example, it is particularly challenging to develop a system that compiles a holistic audit log that encompasses changes by all classifications of end users across all subsystems.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments of the present invention provide and utilize a unifying domain model for Internet business systems. In at least one implementation, the unifying domain model includes an authoritative definition of logical objects that make up a modern Internet business system, a canonical list of attributes associated with such objects, a specification of how such objects may be composed and may relate to one another, and what operations or actions may be taken on or provided by them. Embodiments of the present invention also include a middleware framework that brokers communication between end-user applications that are designed to consume the aforementioned objects and various integrated systems that are not so designed, such as LOB systems and partner systems. Such communication brokering may include performing a translation between a representation of the data and operations utilized by at least one of the integrated systems and the unifying domain model utilized by the end-user applications during runtime of the end-user applications.

By providing an agreed upon set of logical objects, their relationships and their behaviors, a unifying domain model for Internet business systems in accordance with an embodiment of the present invention addresses the difficulties described in the background section above with respect to integrating Internet business systems with associated UI components, back-end LOB systems, management tools and UI suites.

With a unifying domain model established, and with a representative set of reference implementations, it is anticipated that the time to integrate various components in an Internet business system will be greatly reduced since the peculiarities of each component will be abstracted based on an agreed-upon authoritative design pattern. Such reduced time to integrate not only applies to an initial integration exercise, but also allows for more rapid upgrades either to new versions or replacements of existing integrated systems, such as existing back-end LOB systems. Improved upgrade capabilities can be accomplished through versioning of the unifying domain model and the ability to make use of bridge patterns across versions in the aforementioned middleware framework.

A further advantage associated with embodiments of the present invention derives from the clarity surrounding object definitions, composition rules, relationships and allowable operations, due to the clear semantic definition of each of these items provided by the unifying domain model. Such clarity helps to prevent downstream defects that can be caused by misinterpretation of the purpose and use of objects, their properties, relationships and operations, and allows for behavior to reliably flow from LOB and partner systems through management tools to the end-user UI.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 illustrates an example of an object definition included in a unifying domain model for an Internet business system in accordance with an embodiment.

FIG. 2 is a block diagram of an Internet business system in accordance with an example embodiment that includes a middleware framework that brokers communication between applications that consume objects defined in accordance with a unifying domain model and various integrated systems that do not.

FIG. 3 depicts a flowchart of a method of operation of an Internet business system that utilizes a unifying domain model in accordance with an embodiment.

FIG. 4 depicts a step that may be performed as part of the processing of a particular data interaction by an Internet business system that utilizes a unifying domain model in accordance with an embodiment.

FIG. 5 depicts an additional step that may be performed as part of the method of operation of the flowchart of FIG. 3 in accordance with an embodiment.

FIG. 6 depicts additional steps that may be performed as part of the method of operation of the flowchart of FIG. 3 in accordance with an embodiment.

FIG. 7 is a block diagram of an example computer system that may be used to implement one or more components of an Internet business system that utilizes a unifying domain model in accordance with an embodiment.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### A. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the art to implement such feature, structure, or characteristic in connection with other embodiments whether or not explicitly described.

Embodiments of the present invention provide and utilize a unifying domain model for Internet business systems. In at least one implementation, the unifying domain model includes an authoritative definition of logical objects that make up a modern Internet business system, a canonical list of attributes associated with such objects, a specification of how such objects may be composed and may relate to one another, and what operations or actions may be taken on or provided by them. Section B, below, provides examples of how such an authoritative set of logical objects, relationships and behaviors may be defined in accordance with various embodiments.

Embodiments of the present invention also include a middleware framework that brokers communication between end-user applications that are designed to consume the aforementioned objects and various integrated systems that are not so designed, such as LOB systems and partner systems, wherein brokering communication may include performing a translation between a representation of the data and operations utilized by an integrated system and the unifying domain model utilized by the end-user applications during runtime of the end-user applications. Example Internet business systems that include such a middleware framework are described below in Section C.

Section D, below, describes example an example computer system that may be utilized to implement various components in an Internet business system that utilizes a unifying domain model in accordance with embodiments of the present invention.

### B. Example Object, Object Relationship and Object Behavior Definitions for Unifying Domain Model in Accordance with an Embodiment

Central to developing a user-experience-oriented architecture for an Internet business system is the notion of developing system interaction “from the UI down.” This entails determining how a user will interact with the system and then designing a framework based on that interaction as opposed to developing a framework abstractly and then hoping to somehow produce a compelling experience using it. Accordingly, in accordance with one embodiment, a list of Internet business objects that a user of the system will work with on a day-to-day basis is enumerated. The objects may be determined by considering system usage from a number of viewpoints, including a consumer, administrative, and LOB integration point of view. In accordance with at least one embodiment, an Internet business system domain model is designed by creating Internet business object definitions at a logical level, ignoring specifics of any system and current limitations thereof.

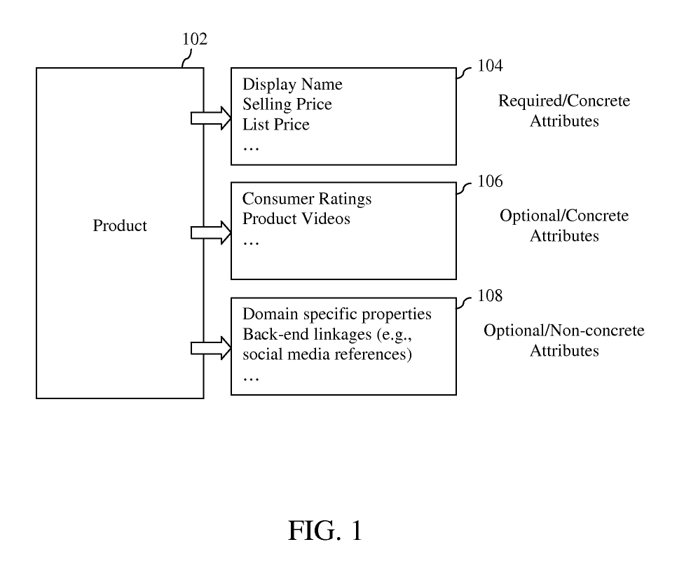

FIG. 1 illustrates an example of an object definition 102 for an Internet business system that includes an e-commerce component. As shown in FIG. 1, the object for which object definition 102 is provided is a Product. As further shown in FIG. 1, object definition 102 includes a set of required/concrete attributes 104, a set of optional/concrete attributes 106 and a set of optional/non-concrete attributes 108. Required attributes refer to attributes that must be specified for every instantiation of an object while optional attributes refer to attributes that may or may not be specified for each instantiation of an object. Concrete attributes refer to attributes that have a defined semantic behavior within the architecture of the Internet business system while non-concrete attributes refer to attributes that that do not have a defined semantic behavior but are nevertheless allowed for by the architecture.

In view of the foregoing explanation of required, optional, concrete and non-concrete, in the illustration of FIG. 1, a Product is required to have at least a Display Name, a Selling Price and a List Price associated therewith since those are required attributes and any UI application operating on a Product would be able to rely on each of these attributes being available for the Product. Furthermore, any UI application interacting with the Product would be able to rely on each of these attributes having a defined semantic behavior, since such attributes are concrete.

In further accordance with the illustration of FIG. 1, a Product can optionally have Consumer Ratings and/or Product Videos associated therewith since those are optional attributes. Any UI application operating on a Product would need to determine whether or not these attributes were populated before interacting with them. However, upon determining that these attributes are populated, the UI application could then depend on such attributes exhibiting a defined semantic behavior, since such attributes are concrete.

In still further accordance with the illustration of FIG. 1, a Product can optionally have domain-specific properties (e.g., Publisher) or back-end linkages (e.g., a populated list of social media references) associated therewith since those are also optional attributes. Any UI application operating on a Product would need to determine whether or not these attributes were populated before interacting with them. Furthermore, even if these attributes are populated, a semantic definition of the behavior of such attributes would be outside of the scope of the system architecture, although the architecture allows for the existence of such attributes.

The foregoing example of FIG. 1 was intended to illustrate one manner of defining Internet business objects for a domain model. Persons skilled in the relevant art(s) will appreciate that other techniques for defining objects may be used. Table 1, below, provides a non-exhaustive, exemplary list of objects that may be included in an Internet business system domain model in accordance with an embodiment.

TABLE 1
Exemplary List of Objects

| | | Specific | |
|---|---|---|---|
| Area | Object | Instantiation | Description |
| Merchandising | Catalog | | Represents a product catalog. |
| | Product | | Represents a product. |
| | Variant | | Represents a variant (SKU) |
| | | | for a Product. |
| | Category | | Represents a category in |
| | | | which a Product resides. |
| | Bundle | | Represents a collection of |
| | | | Products which make up a |
| | | | single bundle for the purposes |
| | | | of an e-commerce transaction. |
| | Rating | | Represents a user rating on a |
| | | | Product. |
| | Review | | Represents a user review of a |
| | | | Product. |
| Marketing | Campaign | | Represents an encompassing |
| | | | digital marketing campaign. |
| | Advertisement | | Represents an advertisement |
| | | | which may be associated with |
| | | | a Campaign. |
| | | Display | An advertisement displayed on |
| | | | a site or within an application. |
| | | Search | An advertisement displayed by |
| | | | an Internet search engine as |
| | | | part of a search results display. |
| | Discount | | Represents a discount on a |
| | | | Product or Bundle. |
| | | Promotional | Represents a non-permanent |
| | | | discount on a Product or |
| | | | Bundle, generally |
| | | | incorporating some business |
| | | | rules. |
| | | Permanent | Represents a permanent |
| | | | markdown in price on a |
| | | | Product or Bundle. |
| | | Coupon | A means of controlling access |
| | | | to a Promotional Discount. |
| | Messaging | | Represents some form of |
| | | | message targeted at a human. |
| | | Email | Represents an email message. |
| | | SMS | Represents a Short Message |
| | | | Service (SMS) message. |
| | | Tweet | Represents a Twitter message. |
| Orders | Shopper | | Represents a human shopper. |
| | Order | | Represents an order in the |
| | | | ecommerce system. |
| | User Group | | Represents a container for a |
| | | | group of shoppers. |
| | List | | Represents a list of Products |
| | | | and/or Bundles. |
| | | Wish | A specific form of a List, used |
| | | | for wish lists. |
| | | Registry | A specific form of a List, used |
| | | | as a registry (e.g., gift registry) |
| | | Recurring | A specific form of a List used |
| | | Order | to place recurring orders. |
| | Cart (CSR) | | Represents the shopping cart. |
| | | | A shopping cart may contain |
| | | | Products, Bundles, Discounts |
| | | | and Advertisements. |
| Content | Media | | Represents some form of |
| | | | media/content specific to the |
| | | | system. |
| | | Static content | Represents static content, for |
| | | | example HTML based copy. |
| | | Image | Represents images, including |
| | | | Product, Category, |
| | | | Advertisement, etc. |
| | | Video | Represents a video. |
| | | User Media | Similar to Media, represents |
| | | | media generated by a Shopper. |
| | | | Will contain all types as a |
| | | | Media object. |
| Payment | Tax | | Represents information on |
| | | | taxes, peculiar to a geographic |
| | | | locale. |
| | Shipping | | Represents shipping |
| | | | information. |
| | Payment | | Represents available payment |
| | Methods | | methods for the e-commerce |
| | | | system |

Once a set of Internet business object definitions has been created, it then becomes possible to design user interfaces to expose interaction with the objects so defined. In accordance with at least one embodiment, an Internet business system domain model is further designed by defining “units of work,” wherein such units of work comprise operations that must be in place to support use of the objects. Such operations may include, for example, create, read, update and delete operations as well as other operations. A unit of work is effectively the task that a user is trying to perform using the Internet business system. Like the object definitions described above, the units of work may be determined by considering system usage from a number of viewpoints, including a consumer, administrative, and LOB integration point of view.

Table 1, below, provides a non-exhaustive, exemplary list of operations that may be performed on objects in an Internet business system in accordance with an embodiment:

TABLE 2
Exemplary List of Operations

| Operation | Description |
|---|---|
| Create | Create a new object. |
| Read | Read an existing object. |
| Update | Update an existing object. |
| Delete | Delete an existing object. |
| Query | Retrieve a set of objects which match a |
| (Search) | supplied search criteria. |
| Hydrate | For objects transferred over the wire in a |
| | dehydrated form (i.e., without related |
| | objects attached), “hydrates” the object, |
| | populating any parent and child |
| | relationships with related object(s), |
| | effectively instantiating an object graph. |

In accordance with certain embodiments, execution of the operations defined for the Internet business system domain model will intrinsically involve recording certain information in an auditing system or recording certain information for subsequent forwarding to such an auditing system. The recorded information may include, for example and without limitation, a user on whose behalf an operation was performed, a time at which the operation was performed, a geo-location associated with the performance of the operation, and/or information about the object upon which the operation was performed.

In certain implementations, execution of a read operation may utilize caching functionality in an intrinsic manner (i.e., without the knowledge of the caller).

### C. Example Structural Design of an Internet Business System in Accordance with an Embodiment

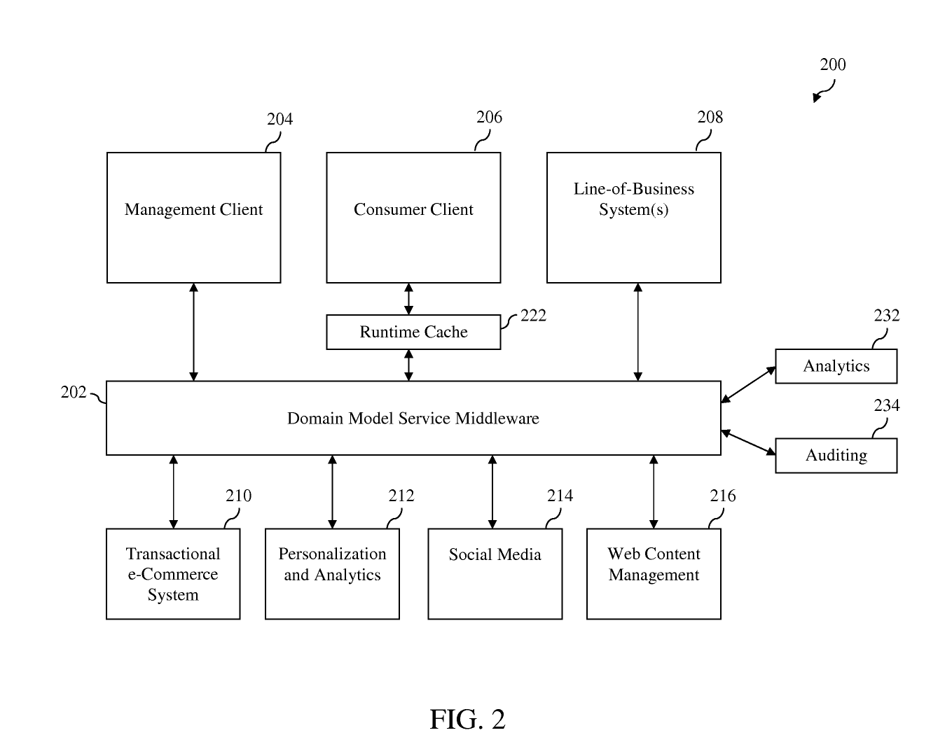

FIG. 2 is a block diagram of an Internet business system 200 in accordance with an example embodiment. The block diagram of FIG. 2 is intended to show one possible structural design of a software implementation of the present invention. As shown in FIG. 2, the design of Internet business system 200 involves the use of middleware (also referred to herein as a “translation layer”). The middleware effectively brokers objects defined in accordance with the aforementioned unifying domain model between applications and systems configured to interact directly with such objects and integrated systems that are not so configured.

In particular, as shown in FIG. 2, Internet business system 200 includes domain model service middleware 202, a management client 204, a consumer client 206, one or more line-of-business (LOB) systems 208, a transactional e-commerce system 210, a personalization and analytics system 212, a social media system 214, a Web content management system 216, a runtime cache 222, an analytics system 232, and an auditing system 234. Each of these components may comprise software running on one or more computers or other processor-based systems or devices. Furthermore, two or more of these components may comprise software running on the same computer or other processor-based system or device. An example computer that may be used to implement one or more of the software components of system 200 will be described below in reference to FIG. 6. Each of these components will now be further described.

Management client 204 is intended to represent a software application that can be utilized by an end-user to perform certain business management operations with respect to Internet business system 200. For example, in an embodiment in which Internet business system 200 comprises an e-commerce system, management client 204 may be utilized by an end-user to perform certain “back office” functions such as merchandising a store (e.g., adding, deleting or changing products or product categories), setting up an ad campaign (e.g., adding, deleting or changing display or search advertisements), managing Web content (e.g., adding, deleting or changing Web content to be displayed to consumers using the Internet business system), or the like. In an embodiment, management client 204 is designed to carry out these functions by performing operations on objects defined in accordance with a unifying data model supported by domain model service middleware 202. In further accordance with such an embodiment, management client 204 may be designed to perform such operations by placing calls to domain model service middleware 202 using a standard application programming interface (API) exposed by domain model service middleware 202 for performing such operations.

Consumer client 206 is intended to represent a software application that can be utilized by a consumer to perform certain functions with respect to Internet business system 200. For example, in an embodiment in which Internet business system 200 comprises an e-commerce system, a consumer may utilize consumer client 206 to perform functions such as search for products, place an order for a product, add a product to a list (e.g., wish list or registry), add a product to an online shopping cart, provide a review or other feedback about a product, obtain information or media associated with a product, submit payment for a product, share information with other consumers, view and/or interact with an advertisement, or the like. In an embodiment, consumer client 204 is designed to carry out these functions by performing operations on objects defined in accordance with a unifying data model supported by domain model service middleware 202. In further accordance with such an embodiment, consumer client 204 may be designed to perform such operations by placing calls to domain model service middleware 202 using a standard API exposed by domain model service middleware 202 for performing such operations.

Consumer client 206 may be implemented in a wide variety of ways as will be appreciated by persons skilled in the relevant art(s). For example, consumer client 206 may comprise a Web browser that can be used to interact with a Web page in a well-known manner. Consumer client 206 may also comprise an application designed for execution on a smart phone. Consumer client 206 may further comprise an application designed for execution on an in-store kiosk. However, these are only examples, and still other manners of implementing consumer client 206 may be used.

Domain model service middleware 202 is intended to represent software that operates to access and perform operations on objects defined in accordance with a unifying domain model (such as the model described in the preceding section) based on API calls placed by at least management client 204 and consumer client 206. The objects may represent data that is stored and/or managed by one or more integrated systems that are connected to domain model service middleware 202. However, such integrated systems may not be configured to support the operations specified by the API calls or the object definitions associated with the unifying domain model. Accordingly, domain model service middleware 202 is configured to perform translation operations necessary to perform the desired operations upon the specified objects. For example, domain model service middleware 202 may translate a unifying domain model operation to be performed on certain target data as specified by a unifying domain model API call to one or more corresponding API calls or operations specific to a particular integrated system that manages and/or stores the target data. Domain model service middleware 202 may also translate between a unifying domain data model representation of the target data and a representation of the target data supported by the particular integrated system.

Domain model service middleware 202 can thus be thought of as residing in “the middle of” and facilitating interaction between one or more end-user applications configured to represent and operate on data in a manner specified by a unifying domain model and one or more integrated systems that are not so configured. The end-user applications are abstracted from the integrated systems and communicate with them solely by way of the domain model and through domain model service middleware 202. To interact with different end-user applications and integrated systems, domain model service middleware 202 may be configured to communicate with such applications and systems using a variety of different protocols, such as a variety of different network and Web services protocols.

In accordance with at least one embodiment, domain model service middleware 202 processes API calls received from management client 204 and consumer client 206 by performing desired operations on specified target data at runtime of those components. This distinguishes Internet business system 200 from certain conventional Internet business systems that rely on enterprise application integration (EAI) tools that operate in an offline manner by brokering messages between heterogeneous system components. By performing the necessary translations at runtime, an embodiment of the present invention can advantageously provide for seamless real-time interaction between various diverse components that make up a modern Internet business system.

Each of the following integrated systems shown in FIG. 2 may represent systems that are configured to represent and operate on data in a manner that is unique to the specific integrated system rather than in a manner specified by the unifying domain model supported by domain model service middleware: LOB system(s) 208, transactional e-commerce system 210, personalization and analytics system 212, social media system 214 and Web content management system 216.

LOB system(s) 208 comprise one or more computer applications, each of which is used to facilitate the management of a particular aspect of an enterprise. Examples of LOB systems include but are not limited to accounting systems, supply chain management systems, resource planning applications, human resources systems, and the like. LOB system(s) 208 may comprise large programs that contain a number of integrated capabilities and tie into databases and database management systems. Often, LOB systems are custom-designed to serve the needs of a particular LOB within a particular enterprise, and thus will utilize a custom-designed data model and associated data operations.

Transactional e-commerce system 210 comprises a software-based system that facilitates the buying and selling of products or services over electronic systems such as the Internet and other networks. For example, transactional e-commerce system 210 may comprise a system that enables consumers to purchase products or services via a Web site or some other interface. Depending upon the implementation, transactional e-commerce system 210 may be independently developed by an enterprise or purchased “off the shelf” from a system vendor. In one embodiment, transaction e-commerce system 210 comprises an e-commerce system developed using Microsoft® Commerce Server, published by Microsoft Corporation of Redmond, Wash. In order to operate, transactional e-commerce system 210 may require some level of integration with certain LOB system(s) 208, such as an inventory system, supply chain management system, accounting system or the like. In the system of FIG. 2, such integration is achieved at least in part via domain model service middleware layer 202.

Personalization and analytics system 212 comprises one or more software applications for delivering targeted and optimized Web content to consumers that access Internet business system 200 via a Web site. Web site personalization and optimization are critical capabilities for organizations to effectively and efficiently compete for customers today. In accordance with an embodiment, personalization and analytics system 212 automatically assigns customers to customer segments in accordance with a set of predefined rules and then personalizes a Web site served by Internet business system 200 based on such customer segmentation, thereby enabling the creation of a Web experience that is automatically tailored and specifically relevant to each site visitor. In accordance with a further embodiment, personalization and analytics system 212 analyzes the effectiveness of Web content at a granular level across pages and sites, as well as across various customer segments. The results of such analysis may then be used to determine the effectiveness of served content so that it can be optimized.

Social media system 214 comprises one or more software applications or tools that enable consumers that interact with Internet business system 200 to share information with others, such as other consumers within a same social network. By way of example only and without limitation, social media system 214 may comprise a forum a system, a blogging engine, a wiki, or a connection to a social networking service such as Facebook® or a microblogging system such as Twitter®.

Web content management system 216 comprises a software-based system that provides Web site authoring, collaboration and administration tools designed to allow users to create and manage the content of a Web site associated with Internet business system 200. In accordance with certain embodiments, Web content management system 216 provides a foundation for collaboration by offering users the ability to manage documents and output for multiple author editing and participation. In certain implementations, Web content management system 216 uses a database to store content, metadata, or artifacts that may be needed thereby.

In accordance with the above-described architecture of system 200, domain model service middleware 202 is configured to translate objects, properties and relationships specified by the unifying domain model and referenced by management client 204 and consumer client 206 into native data constructs and API calls that can be processed by the various integrated systems with which middleware 202 communicates. Domain model service middleware 202 is also responsible for the composition of unifying domain model objects from data obtained from the separate integrated systems, thereby providing a seamless view of Internet business system 200 and disguising its heterogeneous nature.

In further accordance with the system architecture shown in FIG. 2, domain model service middleware 202 can advantageously observe and enforce relationships between data managed by different integrated systems, even though such integrated systems are not “aware” of such relationships (i.e., are not configured to observe and enforce such relationships).

As part of the above-described translation and communication process performed by domain model service middleware 202, domain model service middleware 202 seamlessly records transactions and captures appropriate event information for the purpose of analysis by analytics system 232 and auditing system 234. For example, as noted in the preceding section, execution of certain data operations by domain model service middleware 202 may intrinsically involve recording certain information such as a user on whose behalf an operation was performed, a time at which the operation was performed, a geo-location associated with the performance of the operation, and/or information about the object upon which the operation was performed.

Since the recording of transactions and capturing of event information occurs at the middleware level, information concerning all the transactions and events occurring within Internet business system 200 can be recorded in a uniform way by domain model service middleware 202 even though such operations may be performed against data maintained by the various integrated system connected thereto. Furthermore, since the recording of transactions and capturing of event information occurs at the middleware level, analytics system 232 and auditing system 234 need only be designed to interface with domain model service middleware 202 to obtain such information, rather than to all the integrated systems. Additionally, since such information can be recorded in a uniform manner as noted above, analytics systems 232 and auditing system 234 need only be designed to process such information in accordance with a single predefined information format utilized by domain model service middleware 202.

In accordance with certain embodiments in which Internet business system 200 comprises an e-commerce system, domain model service middleware 202 can be leveraged to provide e-commerce related objects beyond those that are provided for by a database schema of transactional e-commerce system 210, as well as to provide additional data operations beyond those that are provided by transactional e-commerce system 210, thereby extending the capabilities of transactional e-commerce system 210 in a seamless manner. This is particularly beneficial in an embodiment in which transactional e-commerce system 210 comprises an “off-the-shelf” component that cannot be modified by an enterprise associated with Internet business system 200.

Furthermore, domain model service middleware 202 can be leveraged to provide new functionality to Internet business system 200 that is not provided for by transactional e-commerce system 210. Thus, for example, domain model service middleware 202 can include a programming interface for integrating advanced UI technologies into Internet business system 200 even though transactional e-commerce system 210 does include such a programming interface. Still other types of functionality may be added that is not provided for by transactional e-commerce system 210 or by any of the other integrated systems included within Internet business system 200. In certain embodiments, domain model service middleware 202 includes a persistent storage capability to store the instructions and data necessary to provide such added functionality.

As further shown in FIG. 2, Internet business system 200 includes a runtime cache 222 that resides between domain model service middleware 202 and consumer client 206. Runtime cache 222 may be used to temporarily store unifying domain model objects that have been recently-accessed and/or frequently-accessed by consumer client 206. By caching recently-accessed and/or frequently-accessed unifying domain model objects, runtime cache 222 can advantageously reduce a number of wire operations that must be performed between domain model service middleware 202 and any of the various integrated systems from which data is obtained to compose such unifying domain model objects.

It is to be understood that runtime cache 222 comprises both the memory required to store cached objects as well as the logic required to manage the cache (e.g., logic to determine when to add or remove an object from the cache, logic to detect cache hits and misses, and the like). Also, although runtime cache 222 is shown in FIG. 2 as being connected to a single consumer client 206, it is to be appreciated that runtime cache 222 may be used to serve multiple consumer clients, thereby improving system efficiency when different end users access the same objects. For example, in certain embodiments, different runtime caches may be used to cache objects for clients/users located in different geographical areas. A modern “cloud” infrastructure may be exploited to allow for such distributed caching and for ensuring coherency between data stored by various distributed caches. Additionally, it is to be understood that a runtime cache may also be utilized between domain model service middleware 202 and management client 204, between domain model service middleware 202 and LOB system(s) 208, or between other components of Internet business system 200 depending upon the implementation.

It is noted that the Internet business system 200 of FIG. 2 has been presented by way of example only and is not intended to be limiting. For example, an Internet business system in accordance with an embodiment of the present invention may include a middleware layer that implements a unifying domain model by brokering communication between other clients and other integrated systems than those shown in FIG. 2.

### D. Example Method of Operation of Internet Business System in Accordance with an Embodiment

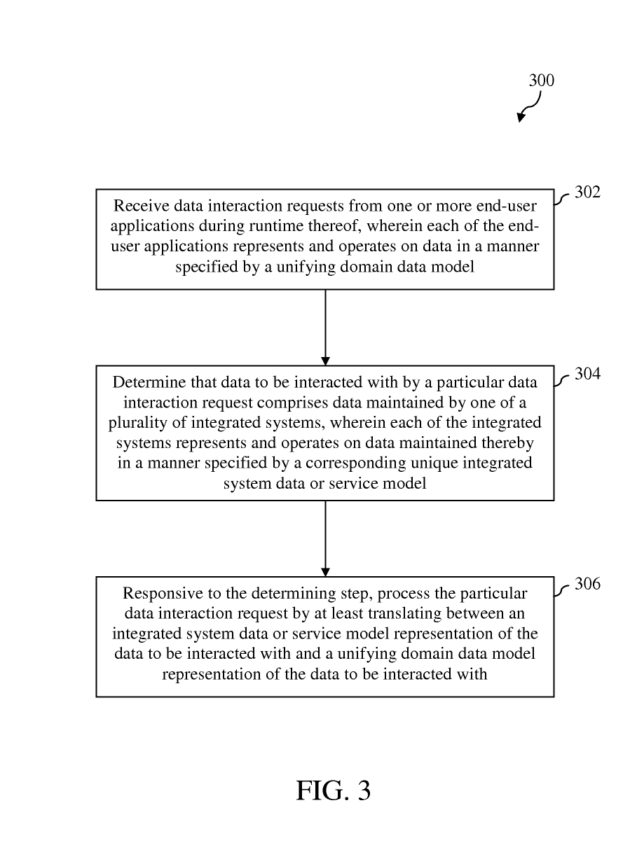

FIG. 3 depicts a flowchart 300 of a method of operation of an Internet business system that utilizes a unifying domain data model in accordance with an embodiment. For the sake of illustration, the method of flowchart 300 will now be described, at least in part, in reference to various components of Internet business system 200 as described above in reference to FIG. 2. However, persons skilled in the relevant arts) will appreciate that the method is not limited to that implementation and may be performed by other components or systems entirely.

As shown in FIG. 3, the method of flowchart 300 begins at step 302, in which data interaction requests are received by domain model service middleware from one or more end-user applications during runtime thereof, wherein each of the end-user applications represents and operates on data in a manner specified by a unifying domain data model. In an embodiment, the domain model service middleware comprises domain model service middleware 202 and the end-user applications comprise one or both of management client 204 and consumer client 206 of Internet business system 200 as described above in reference to FIG. 2, although this example is not intended to be limiting. The unifying domain model referred to in this step may be a data model designed in accordance with any of the various principles and examples set forth above in Section B, although this is only an example.

In at least one embodiment, receiving the data interaction requests from the one or more end-user applications during runtime thereof comprises receiving the data interaction requests via a common application programming interface exposed by the domain model service middleware.

At step 304, the domain model service middleware determines that data to be interacted with by a particular data interaction request received during step 302 comprises data maintained by one of a plurality of integrated systems, wherein each of the integrated systems represents and operates on data maintained thereby in a manner specified by a corresponding unique integrated system data or service model. In an embodiment, the plurality of integrated systems includes one or more of LOB system(s) 208, transactional e-commerce system 210, personalization and analytics system 212, social media system 214 and Web content management system 216 as described above in reference to FIG. 2, although these examples are not intended to be limiting.

At step 306, responsive to the determining step 304, the domain model service middleware processes the particular data interaction request by at least translating between an integrated system data or service model representation of the data to be interacted with and a unifying domain data model representation of the data to be interacted with.

In accordance with at least one embodiment, the unifying domain data model referred to in flowchart 300 comprises a plurality of Internet business object definitions. In a further embodiment, each Internet business object definition specifies one or more required attributes associated with an Internet business object and optionally specifies one or more optional attributes associated with the Internet business object. In a still further embodiment, each required attribute is designated as concrete and each optional attribute may be designated as concrete or non-concrete, wherein a concrete attribute is an attribute having a defined semantic behavior. In accordance with yet another embodiment, each Internet business object definition specifies one or more operations that support the use of a corresponding Internet business object in a user interface.

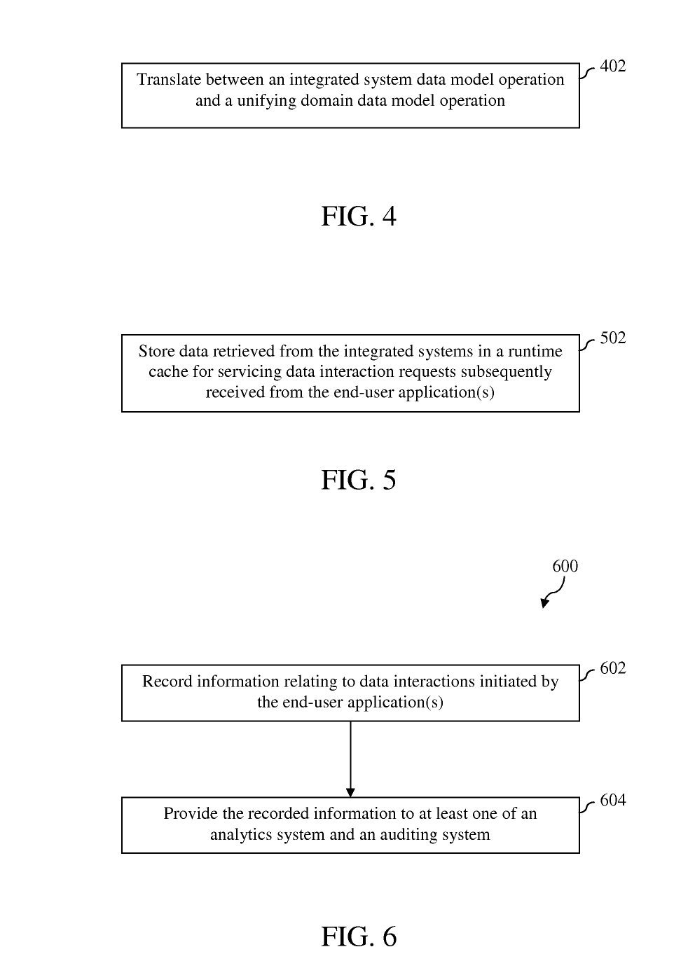

FIG. 4 depicts an additional step 402 that may be performed as part of processing the particular data interaction during step 306. In particular, as shown in FIG. 4, processing the particular data interaction may further comprise translating between an integrated system data model operation and a unifying domain data model operation.

FIG. 5 depicts an additional step that may be performed as part of the method of operation of flowchart 300. In particular, as shown in FIG. 5, the method of operation may further include storing data retrieved from the integrated systems in a runtime cache for servicing data interaction requests subsequently received from the end-user application(s). In an embodiment, the runtime cache comprises runtime cache 222 as described above in reference to FIG. 2, although this is only an example.

FIG. 6 depicts additional steps that may be performed as part of the method of operation of flowchart 300. In particular, as shown in FIG. 6, the method of operation may include recording information relating to data interactions initiated by the end-user application(s) during step 602 and providing the recorded information to at least one of an analytics system and an auditing system during step 604. In an embodiment, the analytics system and auditing system comprise analytics system 232 and auditing system 234 as described above in reference to FIG. 2, although this is only an example.

### E. Example Computer System Implementation

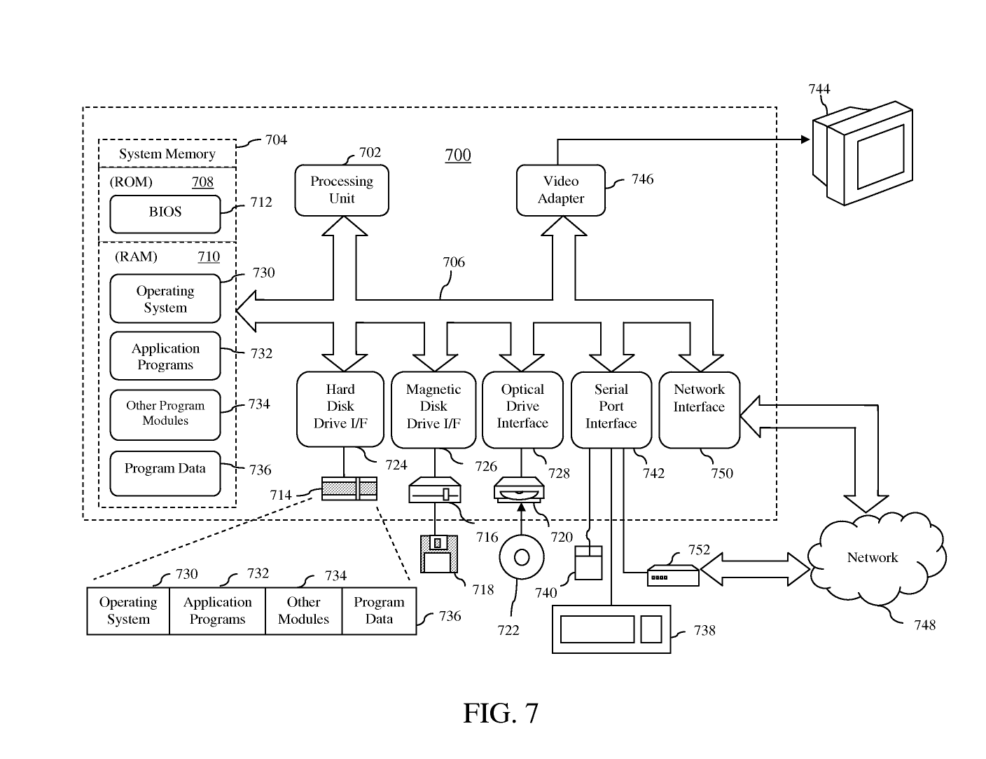

FIG. 7 is a block diagram of an exemplary implementation of a computer 700 upon which one or more of the software components of an Internet business system, such as Internet business system 200, may be executed. Computer 700 may comprise, for example, a general-purpose computing device in the form of a conventional personal computer although that is only one example.

As shown in FIG. 7, computer 700 includes a processing unit 702, a system memory 704, and a bus 706 that couples various system components including system memory 704 to processing unit 702. Bus 706 represents one or more of any of several types of bus structures, including a memory bus or memory controller, a peripheral bus, an accelerated graphics port, and a processor or local bus using any of a variety of bus architectures. System memory 704 includes read only memory (ROM) 708 and random access memory (RAM) 710. A basic input/output system 712 (BIOS) is stored in ROM 708.

Computer 700 also has one or more of the following drives: a hard disk drive 714 for reading from and writing to a hard disk, a magnetic disk drive 716 for reading from or writing to a removable magnetic disk 718, and an optical disk drive 720 for reading from or writing to a removable optical disk 722 such as a CD ROM, DVD ROM, or other optical media. Hard disk drive 714, magnetic disk drive 716, and optical disk drive 720 are connected to bus 706 by a hard disk drive interface 724, a magnetic disk drive interface 726, and an optical drive interface 728, respectively. The drives and their associated computer-readable media provide nonvolatile storage of computer-readable instructions, data structures, program modules and other data for the server computer. Although a hard disk, a removable magnetic disk and a removable optical disk are described, other types of computer-readable media can be used to store data, such as flash memory cards, digital video disks, random access memories (RAMs), read only memories (ROM), and the like.

A number of program modules may be stored on the hard disk, magnetic disk, optical disk, ROM, or RAM. These programs include an operating system 730, one or more application programs 732, other program modules 734, and program data 736. Application programs 732 or program modules 734 may include, for example, logic for implementing one or more of the components of Internet business system 200 or one or more of the steps shown in FIGS. 3-6 as described above.

A user may enter commands and information into the computer 700 through input devices such as keyboard 738 and pointing device 740. Other input devices (not shown) may include a microphone, joystick, game pad, satellite dish, scanner, or the like. These and other input devices are often connected to processing unit 702 through a serial port interface 742 that is coupled to bus 706, but may be connected by other interfaces, such as a parallel port, game port, or a universal serial bus (USB).

A monitor 744 or other type of display device is also connected to bus 706 via an interface, such as a video adapter 746. In addition to the monitor, computer 700 may include other peripheral output devices (not shown) such as speakers and printers.

Computer 700 is connected to a network 748 (e.g., the Internet) through a network interface or adapter 750, a modem 752, or other means for establishing communications over the network. Modem 752, which may be internal or external, is connected to bus 706 via serial port interface 742.

As used herein, the terms “computer program medium” and “computer-readable medium” are used to generally refer to media such as the hard disk associated with hard disk drive 714, removable magnetic disk 718, removable optical disk 722, as well as other media such as flash memory cards, digital video disks, random access memories (RAMs), read only memories (ROM), and the like.

As noted above, computer programs (including application programs 732 and other program modules 734) may be stored on the hard disk, magnetic disk, optical disk, ROM, or RAM. Such computer programs may also be received via network interface 750 or serial port interface 742. Such computer programs, when executed, enable computer 700 to implement features of the present invention discussed herein. Accordingly, such computer programs represent controllers of the server computer 700.

The invention is also directed to computer program products comprising software stored on any computer useable medium. Such software, when executed in one or more data processing devices, causes a data processing device(s) to operate as described herein. Embodiments of the present invention employ any computer-useable or computer-readable medium, known now or in the future. Examples of computer-readable mediums include, but are not limited to storage devices such as RAM, hard drives, floppy disks, CD ROMs, DVD ROMs, zip disks, tapes, magnetic storage devices, optical storage devices, MEMs, nanotechnology-based storage devices, and the like.

### F. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. An Internet business system, comprising:
a plurality of integrated systems, each of which represents and operates on data maintained thereby in a manner specified by a corresponding unique integrated system data model;
one or more end-user applications that represent and operate on data in a manner specified by a unifying domain data model;
a translation layer that processes data interaction requests received from the end-user application(s) during runtime thereof, wherein processing a data interaction request includes at least determining that data to be interacted with comprises data maintained by one of the integrated systems and translating between an integrated system data or service model representation of the data to be interacted with and a unifying domain data model representation of the data to be interacted with.

2. The Internet business system of claim 1, wherein the plurality of integrated systems includes at least one of:
a line of business (LOB) system;
a transactional e-commerce system;
a personalization and analytics system;
a social media system; and
a Web content management system.

3. The Internet business system of claim 1, wherein the one or more end-user applications includes at least one of:
a business management application; and
a consumer application.

4. The Internet business system of claim 1, wherein processing a data interaction request further includes translating between an integrated system data model operation and a unifying domain data model operation.

5. The Internet business system of claim 1, wherein each end-user application interacts with the translation layer using a common application programming interface.

6. The Internet business system of claim 1, wherein the unifying domain data model comprises a plurality of Internet business object definitions, each Internet business object definition specifying one or more required attributes associated with an Internet business object and optionally specifying one or more optional attributes associated with the Internet business object.

7. The Internet business system of claim 6, wherein each required attribute is designated as concrete and wherein each optional attribute may be designated as concrete or non-concrete, wherein a concrete attribute is an attribute having a defined semantic behavior.

8. The Internet business system of claim 6, wherein each Internet business object definition specifies one or more operations that support the use of a corresponding Internet business object in a user interface.

9. The Internet business system of claim 1, wherein the translation layer is configured to store data retrieved from the integrated systems in a runtime cache for servicing subsequent data interaction requests received from the end-user application(s).

10. The Internet business system of claim 1, wherein the translation layer records information concerning data interactions initiated by the end-user application(s), the system further comprising:
at least one of an analytics system and an auditing system that processes the recorded information.

11. A method of operating of an Internet business system, comprising:
receiving data interaction requests from one or more end-user applications during runtime thereof, wherein each of the end-user applications represents and operates on data in a manner specified by a unifying domain data model;
determining that data to be interacted with by a particular data interaction request comprises data maintained by one of a plurality of integrated systems, wherein each of the integrated systems represents and operates on data maintained thereby in a manner specified by a corresponding unique integrated system data or service model; and
responsive to the determining step, processing the particular data interaction request by at least translating between an integrated system data or service model representation of the data to be interacted with and a unifying domain data model representation of the data to be interacted with.

12. The method of claim 11, wherein determining that the data to be interacted with by the particular data interaction request comprises data maintained by one of the plurality of integrated systems comprises determining that the data to be interacted with by the particular data interaction request comprises data maintained by one of:
a line of business (LOB) system;
a transactional e-commerce system;
a personalization and analytics system;
a social media system; and
a Web content management system.

13. The method of claim 11, wherein receiving the data interaction requests from the one or more end-user applications comprises receiving data interaction requests from one or more of:
a business management application; and
a consumer application.

14. The method of claim 11, wherein processing the particular data interaction request further comprises:
translating between an integrated system data model operation and a unifying domain data model operation.

15. The method of claim 11, wherein receiving the data interaction requests from the one or more end-user applications during runtime thereof comprises receiving the data interaction requests via a common application programming interface.

16. The method of claim 11, wherein the unifying domain data model comprises a plurality of Internet business object definitions, each Internet business object definition specifying one or more required attributes associated with an Internet business object and optionally specifying one or more optional attributes associated with the Internet business object.

17. The method of claim 16, wherein each required attribute is designated as concrete and wherein each optional attribute may be designated as concrete or non-concrete, wherein a concrete attribute is an attribute having a defined semantic behavior.

18. The method of claim 16, wherein each Internet business object definition specifies one or more operations that support the use of a corresponding Internet business object in a user interface.

19. The method of claim 11, further comprising:
storing data retrieved from the integrated systems in a runtime cache for servicing data interaction requests subsequently received from the end-user application(s).

20. The method of claim 11, further comprising:
recording information relating to data interactions initiated by the end-user application(s); and
providing the recorded information to at least one of an analytics system and an auditing system.

21. A computer program product comprising a computer-readable storage medium having computer program logic recorded thereon, the computer program logic comprising:
first means for enabling a processing unit to receive data interaction requests from one or more end-user applications during runtime thereof, wherein each of the end-user applications represent and operate on data in a manner specified by a unifying domain data model;
second means for enabling the processing unit to determine that data to be interacted with by a particular data interaction request comprises data maintained by one of a plurality of integrated systems, wherein each of the integrated systems represents and operates on data maintained thereby in a manner specified by a corresponding unique integrated system data model; and
third means for enabling the processing unit to process the particular data interaction request responsive to the determination by at least translating between an integrated system data model representation of the data to be interacted with and a unifying domain data model representation of the data to be interacted with.

22. An Internet business system, comprising:
one or more clients configured to generate data interaction requests; and
a software architecture configured to receive the data interaction requests over the Internet and to process the received data interaction requests by performing one or more of a predefined set of operations specified by an Internet business domain model upon one or more Internet business objects defined in accordance with the Internet business domain model, wherein each Internet business object specifies one or more required attributes and optionally specifies one or more optional attributes, and wherein each required attribute is designated as concrete and each optional attribute may be designated as concrete or non-concrete, wherein a concrete attribute is an attribute having a defined semantic behavior.
